(19) United States
(12) Patent Application Publication
(10) Pub. No.: US 2025/0235973 A1
(43) Pub. Date: Jul. 24, 2025

(54) METHOD AND APPARATUS FOR SHARPENING A TOOL

(71) Applicant: Taylor Toolworks, LLC, Columbia, MO (US)

(72) Inventor: Michael Kas Taylor, Columbia, MO (US)

(73) Assignee: Taylor Toolworks, LLC, Columbia, MO (US)

(21) Appl. No.: 18/416,013

(22) Filed: Jan. 18, 2024

(51) Int. Cl. B24B 3/54; B23B 51/08

(52) U.S. Cl. CPC B24B 3/54; B23B 51/08

(57) ABSTRACT

A tool sharpening kit to sharpen a tool. The kit includes at least of a support disc, an arbor, and a sharpening disc. The support disc defines an aperture to receive the arbor. The arbor is receivable through the aperture of the support disc while also being adapted to connect to a drill press. The sharpening disc is configured to connect with the support disc while also having a sharpening surface to sharpen a tool. The support disc, arbor, and sharpening disc are collectively rotatable relative to the drill press for providing a tool sharpening kit.

### TECHNICAL FIELD

This disclosure is directed to a woodworking kit for sharpening a tool that is retrofitted to a conventional rotary machine.

### BACKGROUND ART

Sharpening a chisel, which is a cutting tool with a flat back and a beveled edge, offers several significant advantages that enhance its performance, longevity, and safety. Sharpening a chisel restores its sharp edge, allowing it to cut through materials with less force. A sharp chisel creates clean and precise cuts, improving the quality of woodworking, carving, or other tasks that require accuracy. A sharp chisel requires less effort to use, making tasks quicker and more efficient. Woodworkers and craftsmen may complete projects faster and with greater ease, as the chisel smoothly glides through the material. A sharp chisel will reduce strain inasmuch as a dull chisel requires more pressure to cut, leading to increased physical strain on the user's hands, wrists, and arms. Sharpening the chisel minimizes the need for excessive force, reducing the risk of fatigue and repetitive strain injuries. A sharp chisel also provides better control over the cut, allowing for finer adjustments and detailed work. This is particularly important in woodworking and intricate projects where precision is essential. Regularly sharpened chisels experience less wear and tear on their cutting edges. This prolongs the overall lifespan of the tool, reducing the frequency of replacements and saving money in the long run.

Others have provided devices or systems for sharpening chisels. For example, U.S. Pat. No. 9,168,626 teaches a sharpening system that comprises a housing crafted from a combination of components, including a base member made from injection molded, tool-grade plastic, a top member constructed from cast aluminum, and sidewall members crafted from aluminum sheeting. At the core of this assembly is an abrasive disc that undergoes rotation during operation, achieving an optimal speed of around 580 revolutions per minute (rpm). This disc is approximately six inches in diameter and ⅜ inch thick. Sheets of coated abrasive, featuring adhesive backing, are attached to the disc's upper and lower surfaces, secured by a threaded fastener through a central aperture. The coated abrasive sheets, similar to sandpaper, include a backing layer or substrate/medium (paper, fiber, cloth, etc.) with adhesive on one side and abrasive particles on the other. Two primary sharpening ports are integral to this system: a wedge-shaped port specialized for efficient sharpening of various cutting tools, and a secondary port designated intended for the sharpening of different tool types. The assembly employs a motor drive assembly responsible for rotating the abrasive disc. This assembly incorporates an electric motor driving a first gear at a higher speed (around 1750 rpm), connected to a second gear through a timing belt mechanism. This gearing arrangement facilitates the desired rotation speed of the disc (580 rpm). The motor which may be a ⅕ horsepower AC induction motor, is supported by threaded standoffs and a compliant motor support flange that houses an impeller. Cooling air is drawn from the surroundings to maintain appropriate operating temperatures. This patent describes a sharpening process that primarily utilizes the wedge-shaped port. The tool designed for this illustration is a chisel that possesses a planar back surface and a beveled leading surface forming a cutting edge. The chisel also includes inclined surfaces and a handle. The wedge-shaped port holds first and second abrasive members aligned to match the chisel's angles. The first abrasive member resides on the disc's underside and rotates, while the second abrasive member, situated on an inclined slope sloped surface, remains stationary or powered for reciprocating motion. During sharpening, the chisel is manually inserted into the port, ensuring contact between its back surface and the stationary second abrasive surface. As the chisel advances, the back surface interacts with this abrasive, leading to honing. Subsequently, the beveled surface comes into contact with the moving first abrasive surface, initiating a grinding action. This process gradually removes material from the chisel's bevel surface, potentially resulting in swarf (grinding debris) and burring (material elongation) along the cutting edge. The chisel is then retracted, sliding against the second abrasive surface to further hone the back surface and remove any resulting burr. This cycle may be repeated multiple times for optimal results. The patent also suggests the use of multiple abrasive discs with varying grit levels to achieve different levels of sharpness, providing a versatile and efficient tool sharpening process.

U.S. Pat. No. 7,112,124 teaches a rotary blade sharpener. The core of the apparatus provides for a platen situated within a housing. Beneath the housing, a right-angled motor is controlled by a foot switch and is engaged with the platen, enabling it to rotate at a rate of around 100 to 200 revolutions per minute. A detachable disc is affixed to the platen's top via an axle and a knurled disc knob. This disc is slightly larger than the platen to enhance grip during removal. An abrasive sheet, marked by pressure-sensitive adhesive on its underside, is positioned on top of the disc. The disc's color-coding denotes the grit of the sheet. An optional alternative includes attaching the abrasive sheet directly to the platen without using the detachable disc. A lubricant container connected to the housing features a tube and valve mechanism, allowing controlled lubricant delivery to the abrasive disc. The housing encompasses a bottom, surrounding walls, and an open top. An adjustable support rack forms a blade holder assembly situated over the platen. The rack features sides connected by transverse rails, with jigs positioned on these rails for holding blades. The jig comprises plates with hooks and clamps for blade positioning. The sharpening process involves placing a blade, such as a chisel, within the jig, securing it against the abrasive sheet, and adjusting the tilt of the rack to ensure proper sharpening angle. The platen rotates, automatically bringing the blade into contact with the abrasive sheet, alleviating the need for manual pressure. Lubricant is applied to the abrasive sheet through a valve-controlled mechanism, with the housing walls designed to catch any scattered lubricant. Furthermore, the apparatus accommodates blade grinding by exposing the blade's back, allowing it to lay flat on the abrasive sheet. The invention introduces a systematic approach to blade sharpening that integrates automated rotational movement, precise angle adjustments, and lubrication control, ultimately improving the efficiency and effectiveness of blade maintenance.

While these machines were well suited for their intended purpose of sharpening chisels, blades or other tools, they have drawbacks inasmuch as their presence occupies space in a craftsman's workshop. These machines are often times expensive as well which may deter a woodworker from purchasing a machine to sharpen tools and instead may just buy new tools to save money. Further, the machines were more labor intensive than the present disclosure. The previous machines were much larger and therefore may have required more labor to move them to create space in the woodworker's shop and the machines may have required more labor to sharpen the tools.

### SUMMARY OF THE INVENTION

The presently disclosed tool sharpening kit enables a woodworker to use a conventional drill press or similar rotary machine to sharpen a conventional chisel. The presently disclosed tool sharpening kit includes a sharpening assembly that is selectively engageable with a chuck of the drill press. The presently disclosed tool sharpening kit also includes a jig that is configured to rest on a drill press table beneath the drill press. The presently disclosed tool sharpening kit may enable a woodworker to sharpen a tool faster. The presently disclosed tool sharpening kit may further enable a wood worker to have more room in their workstation and may allow them to save money and resources. The following description of the presently disclosed tool sharpening kit addresses some of the inadequacies provided in conventional tool sharpening machines.

One unique aspect of one embodiment of the present disclosure is that it enables a conventional drill press to be retrofit into a chisel or tool sharpening kit. Previous chisel sharpening systems that use rotatable disc required large housings and motors as standalone machines. One exemplary embodiment of the sharpening system of the present disclosure eliminates this need and provides a more practical application of using a rotating disc to sharpen a chisel, blade, or other tool. For example, woodworkers ordinarily have a drill press in their workshop. The present disclosure provides a system that exploits the functionality and presence of a drill press by providing an implement or attachment that couples to and is driven by the drill press to result in a rotary sharpening surface. One embodiment provides a disc having an abrasive substance, wherein the disc is connected to a central arbor that is selectively coupled by the craftsman to the drill press. The drill press motor is positioned above the disc and the primary sharpening surface or abrasive surface is oriented downward. A jig is placed below the disc (and its downwardly facing abrasive surface). The jig supports the chisel, blade, or tool that is to be sharpened.

In one aspect, an exemplary embodiment of the present disclosure may provide a sharpening kit. The sharpening kit includes a sharpening assembly. The sharpening assembly includes a support disc having an upper surface and a lower surface, wherein the support disc defines an aperture that extends between the upper surface and the lower surface of the support disc. The sharpening assembly also includes a sharpening disc having an abrasive surface, wherein the sharpening disc is configured to connect to one of the lower surface of the support disc and the upper surface of the support disc. The sharpening assembly also includes an arbor receivable through the aperture in the support disc, wherein the arbor is adapted to connect a drill press to cause the sharpening assembly to hang downwardly therefrom. The sharpening kit also includes the sharpening assembly is connected to the drill press; the drill press is retrofit to sharpen a tool via the sharpening assembly.

This exemplary embodiment or additional exemplary embodiment may further include a stropping disc operably engageable with the upper surface of the support disc. This exemplary embodiment or additional exemplary embodiment may further include a first adhesive layer between the support disc and the stropping disc; and a second adhesive layer between the support disc and the sharpening disc. This exemplary embodiment or additional exemplary embodiment may further include a honing compound adapted to be spread along an upper surface of the stropping disc. This exemplary embodiment or additional exemplary embodiment may further include a jig having a sloped surface; wherein the jig is adapted to support the tool to be sharpened by the abrasive surface of the sharpening disc. This exemplary embodiment or additional exemplary embodiment may further include a fence that is removably engaged with the jig; wherein the fence is adapted to support the tool to be sharpened by the abrasive surface. This exemplary embodiment or additional exemplary embodiment may further include that the jig further comprises: a base; an upright support operably engaged with the base and defining the sloped surface; at least one mounting surface defined along the upright support and being adjacent to the sloped surface; wherein the fence is removably engaged with the at least one mounting surface. This exemplary embodiment or additional exemplary embodiment may further include a storage passageway defined by the base or the upright support; wherein the arbor is configured to be receivable by the jig at the storage passageway. This exemplary embodiment or additional exemplary embodiment may further include a fence which may include: a brace removably engaged with the sloped surface between a first position and a second position relative to the sloped surface; wherein the brace is adapted to support a second tool in the first position or the second position. This exemplary embodiment or additional exemplary embodiment may further include a first bracing wall of the brace; wherein the first bracing wall is adapted to support the second tool in the first position. This exemplary embodiment or additional exemplary embodiment may further include the fence which may further include: a second bracing wall of the brace opposite to the first bracing wall; wherein the second bracing wall is adapted to support the second tool in the second position. This exemplary embodiment or additional exemplary embodiment may further include a second sharpening disc having a second abrasive surface and configured to connect to the upper surface of the support disc; wherein the second abrasive surface of the second sharpening disc and the abrasive surface of the sharpening disc are different from one another. This exemplary embodiment or additional embodiment may further include a reference tool adapted to check the tool subsequent to being sharpened by the sharpening disc.

In another aspect, an exemplary embodiment of the present disclosure may provide a method of sharpening a tool. The method of sharpening a tool includes the steps of: inserting an arbor of a sharpening kit into an aperture defined in a support disc of the sharpening kit, wherein said aperture extends between an upper surface of the support disc and a lower surface of the support disc; securing a sharpening disc having an abrasive surface to the lower surface of the support disc; engaging the arbor with the support disc and the sharpening disc to a drill press, wherein engagement of the arbor with the drill press causes the support disc and the sharpening disc to hang downward from the drill press; rotating the arbor, the support disc, and the sharpening disc collectively by the drill press; and sharpening the tool with the sharpening disc.

This exemplary embodiment or additional exemplary embodiment may further include the step of positioning a jig of the sharpening kit below the abrasive surface; and supporting the tool on a sloped surface of the jig. This exemplary embodiment or additional embodiment may further include the step of engaging a fence with an upright support of the jig, wherein the fence is positioned adjacent to the sloped surface; and supporting the tool with the fence. This exemplary embodiment or additional embodiment may further include the step of engaging a fence with the sloped surface of the jig; and supporting a second tool with the sloped surface and the fence. This exemplary embodiment or additional exemplary embodiment may further include the step of engaging a stropping disc to the upper surface of the support disc; and coating the stropping disc with a honing compound. This exemplary embodiment or additional exemplary embodiment may further include checking a cutting edge of the tool to a reference tool subsequent to being sharpened by the sharpening disc.

In yet another aspect, another exemplary embodiment of the present disclosure may provide a method of retrofitting a drill press into a tool sharpening device, this exemplary method comprising: providing a drill press having a motor and a chuck that is selectively opened and closed; opening the chuck; inserting an arbor of a sharpening assembly into the opened chuck; closing the chuck to connect the arbor to the drill press; and suspending, via the arbor connected to the chuck, a sharpening disc downward from the drill press to thereby retrofit the drill press and connected sharpening assembly into a tool sharpening device that sharpens a tool.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a front elevation view of a tool sharpening kit that is operably engaged with a drill press in accordance with one aspect of the present disclosure.

FIG. 2 (FIG. 2) is a partial side elevation view of the tool sharpening kit that is operably engaged with the drill press as shown in FIG. 1.

FIG. 3 (FIG. 3) is a top isometric view of the tool sharpening kit that includes a sharpening assembly, a honing compound, a jig, a first fence, a second fence, a reference tool, and feet that engage with the reference tool.

FIG. 4 (FIG. 4) is an exploded perspective view of the sharpening assembly.

FIG. 5 (FIG. 5) is a top perspective view of the assembled sharpening assembly shown in FIG. 4.

FIG. 6 (FIG. 6) is a cross section view of the assembled sharpening assembly taken along line 6-6 in FIG. 5.

FIG. 7A (FIG. 7A) is an exploded top perspective view of the jig and the first fence.

FIG. 7B (FIG. 7B) is a top isometric view of the jig and the first fence assembled with one another.

FIG. 8 (FIG. 8) is a side elevation view of the jig and the first fence assembled with one another.

FIG. 9A (FIG. 9A) is an operational perspective view of the tool sharpening kit interacting with the drill press, wherein the tool is placed on a sloped surface of the jig and abuts the first fence.

FIG. 9B (FIG. 9B) is another operational perspective view continuing from FIG. 9A, wherein the tool is engaged with the sharpening disc while maintaining contact with the sloped surface of the jig and the first fence.

FIG. 9C (FIG. 9C) is an operational cross section view taken along line 9C-9C in FIG. 9B.

FIG. 9D (FIG. 9D) is another operational perspective view continuing from FIG. 9B, wherein the honing compound is applied and coated along the stropping disc.

FIG. 9E (FIG. 9E) is another operational perspective view continuing from FIG. 9D, wherein a cutting edge of the tool is sharpened with the stropping disc at a first position.

FIG. 9F (FIG. 9F) is another operational perspective view similar to FIG. 9E, but the cutting edge of the tool is sharpened with the stropping disc at a second position.

FIG. 9G (FIG. 9G) is an operational perspective view depicting the cutting edge of the resting along the reference tool to confirm that the cutting edge of the tool is flat and/or straight.

FIG. 10 (FIG. 10) is a top perspective view of the second fence.

FIG. 11A (FIG. 11A) is an exploded perspective view of the second fence and the jig.

FIG. 11B (FIG. 11B) is a top perspective view of the second fence assembled to the jig.

FIG. 12A (FIG. 12A) is an operational perspective view of a second tool resting on the sloped surface of the jig and a brace of the second fence.

FIG. 12B (FIG. 12B) is another operational view similar to FIG. 12A, but the second tool is engaging with the sharpening disc of the sharpening assembly while engaging the sloped surface of the jig and the brace of the second fence.

FIG. 13 (FIG. 13) is a top perspective view of the jig supporting the sharpening assembly at a storage passageway defined in the jig.

FIG. 14 (FIG. 14) is a flowchart depicting one exemplary method of sharpening a tool.

FIG. 15 (FIG. 15) is a flowchart depicting one exemplary method of retrofitting a drill press into a tool sharpening device.

Similar numbers refer to similar parts throughout the drawings.

### DETAILED DESCRIPTION

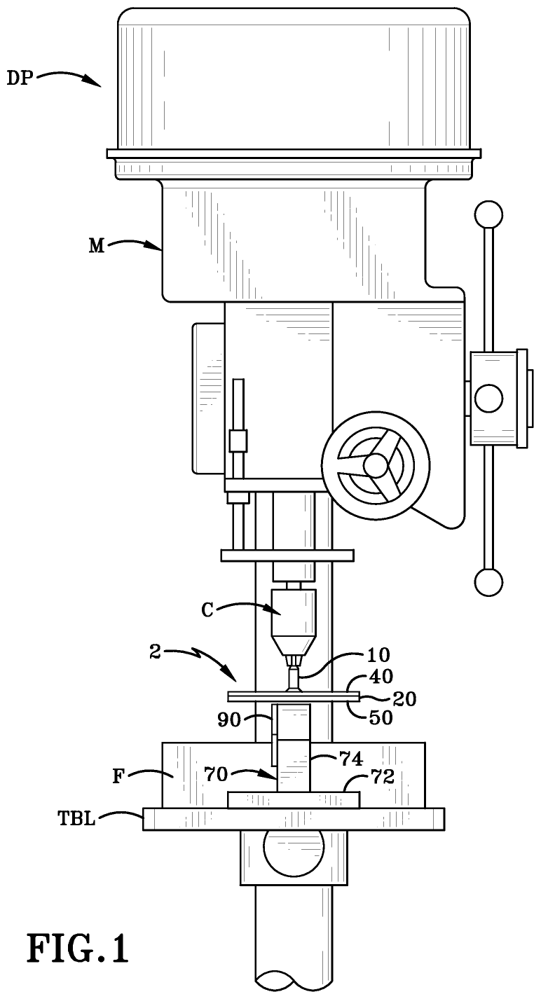

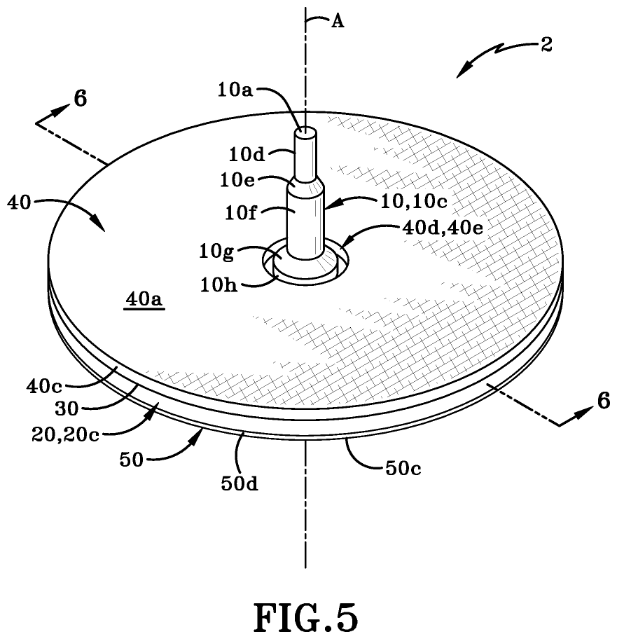

A new tool sharpening kit and method of the present disclosure is depicted throughout FIGS. 1-13 and the kit is shown generally as 1. The tool sharpening kit 1 (hereinafter “kit 1”) is a new and improved way to sharpen various tools with a small and compact kit that every woodworker, carpenter, or handyman would use on a day-to-day basis. The kit 1 may sharpen tools quickly, which is advantageous to a woodworker. As described in greater detail below, the kit 1 provides a new use for a tool that most, if not all, craftsmen already have in their workstation. In one embodiment, the tool that is to be sharpened is a chisel, however the kit 1 may be used to sharpen any device that has an edge needing to be sharpened.

In the illustrated embodiment, the kit 1 may comprise some or all of the following components: an arbor 10, a support disc 20, a securing member 30, a stropping disc 40, a sharpening disc 50, which together forms a sharpening assembly 2. Kit 1 may further comprise a honing compound 60, a jig 70, a first fence 90, a second fence 92, a reference tool 110, and feet 120.

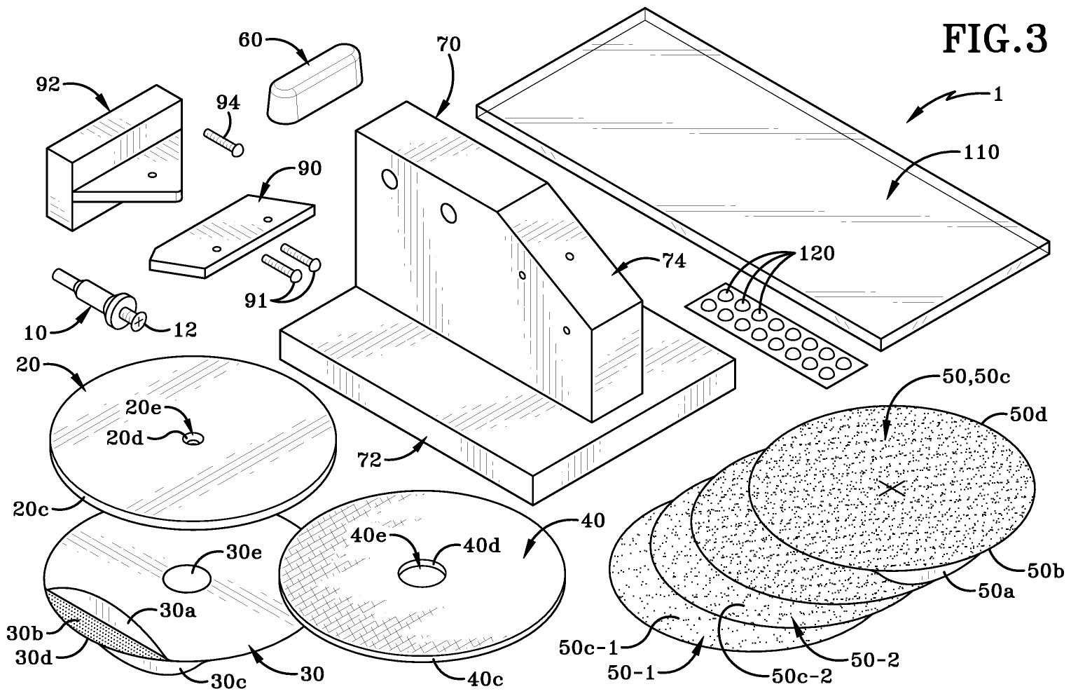

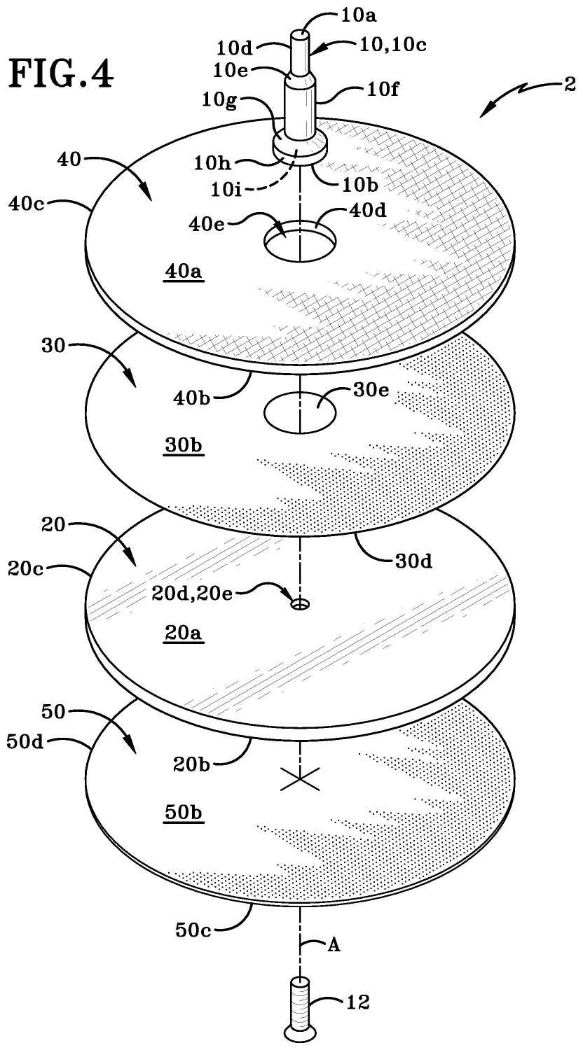

As best seen in FIG. 3 and FIG. 4, arbor 10 of kit 1 includes a top end 10a, a bottom end 10b opposite to the top end, and a cylindrical wall 10c extending between the top end 10a and the bottom end 10b. Extending from the top end 10a, the cylindrical wall 10c includes a first straight wall section 10d which leads into a first tapered wall section 10e. Leading from the first tapered wall section 10e, cylindrical wall 10c also includes a second straight section 10f which connects a second tapered wall section 10g to the first tapered wall section 10e. Wherein the second straight section 10f has a greater diameter than first straight wall section 10d. The second tapered wall section 10g is adjacent to a third straight wall section 10h that extends between the second tapered wall section 10g and the bottom end 10b of the arbor 10. Arbor 10 also defines a threaded passageway 10i that extends upwardly into the arbor 10 from the bottom end 10b towards the top end 10a; such use of the threaded passageway 10i is discussed in greater detail below.

As best seen in FIG. 4, kit 1 also includes a fastener 12 that is receivable by the arbor 10. In operation, fastener 12 is threadably engaged with the arbor 10 inside of the threaded passageway 10i. As discussed in greater detail below, the fastener 12 is configured to engage with one or more sharpening discs and/or stropping discs of kit 1 to maintain or secure the one or more sharpening discs and/or stropping discs with the arbor 10 during a sharpening operation. In another exemplary embodiment the kit 1 may also include washers and/or spacers to ensure that the arbor 10 extends downwardly from the drill press so that it may come in to contact with the tool to be sharpened.

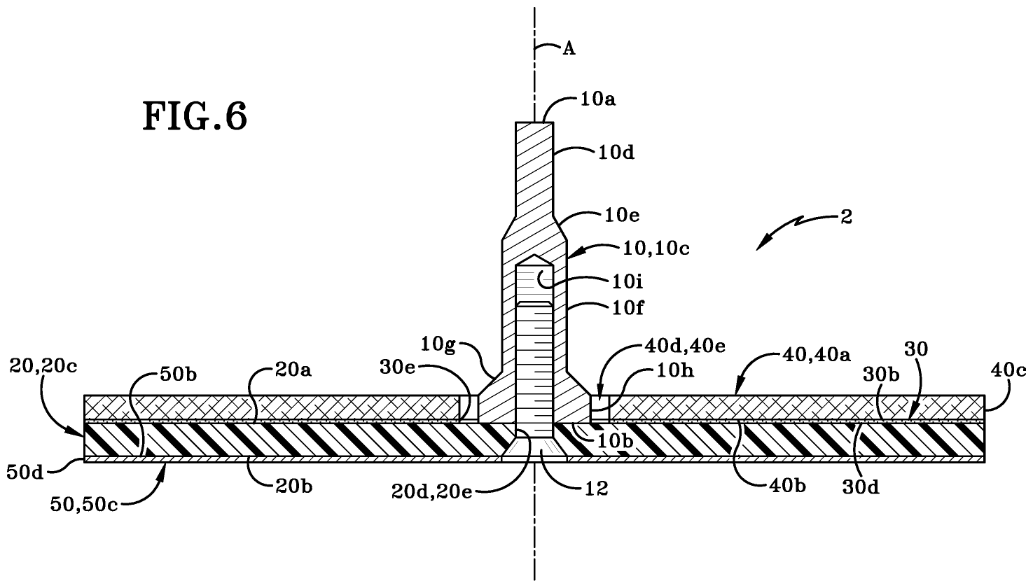

With continued reference to FIG. 3 and FIG. 4, support disc 20 of kit 1 includes an upper surface 20a, a lower surface 20b that is opposite to the upper surface 20a, and a peripheral wall 20c that extends between the upper surface 20a and the lower surface 20b defining the thickness of the support disc 20. The support disc 20 also includes an interior wall 20d that defines an opening 20e. As best seen in FIG. 6, opening 20e extends entirely through the support disc 20 between the upper surface 20a and the lower surface 20b. It should be understood that the upper surface 20a and the lower surface 20b are in open communication with one another through the opening 20e. In one particular embodiment, opening 20e may be countersunk relative to the lower surface 20b.

Arbor 10 and support disc 20 are connected through opening 20e by inserting the fastener 12 through the opening 20e of the support disc 20 from the lower surface 20b of the support disc 20. Once the fastener 12 is inserted through the support disc 20, the head of the fastener 12 lays flush with the lower surface 20b of the support disc 20 because of the opening 20e may be countersunk. The arbor 10 then receives the fastener 12 such that the fastener 12 threadably engages with the arbor 10 inside of the threaded passageway 10i to secure the arbor 10 and the support disc 20 with one another. The insertion of the fastener 12 with arbor 10 creates an axis (denoted by dashed line labeled “A” in FIGS. 4-6) in which the sharpening assembly 2 will rotate about when an external rotational force is applied to the sharpening assembly 2.

With continued reference to FIG. 3 and FIG. 4, securing member 30 of kit 1 has a first removable liner 30a that attaches to and protects a first securing surface 30b which may include adhesive. Securing member 30 also has a second removable liner 30c which is opposite to the first removable liner 30a and attaches to and protects a second securing surface 30d. Securing member 30 also defines an opening 30e through each of the first removable liner 30a, the first securing surface 30b, the second removable liner 30c, and the second securing surface 30d which may include adhesive. When the first removable liner 30a and the second removable liner 30c are removed, the opening 30e is defined by securing member 30 and only extends between the first securing surface 30b and the second securing surface 30d.

Securing member 30 and support disc 20 are attached by means of the second securing surface 30d adhering with the upper surface 20a of the support disc 20. Prior to such securement, a woodworker removes the second removable liner 30c from the securing member 30 to expose the adhesive of the second securing surface 30d. The opening 30e of the securing member 30 and the opening 20e of the support disc 20 are also aligned with one another so that they may both receive the arbor 10 through the opening 30e of the securing member 30 and the opening 20e of the support disc 20.

In the present disclosure, the securing member 30 is an adhesive disc that includes opposing adhesive surfaces for securing the securing member 30 to the support disc 20. In other exemplary embodiments, securing member 30 discussed and illustrated herein may be any suitable securing member that secures to the support disc 20. In one exemplary embodiment, securing member may be a hook-and-loop fastener that attaches to one of the surfaces of the support disc 20 having a matching hook-and-loop fasteners.

With continued reference to FIG. 3 and FIG. 4, stropping disc 40 of kit 1 includes an upper surface 40a, a lower surface 40b that is opposite to the upper surface 40a, and a peripheral wall 40c that extends between the upper surface 40a and the lower surface 40b defining the thickness of the stropping disc 40. The stropping disc 40 also includes an interior wall 40d that defines an opening 40e. As best seen in FIG. 4, opening 40e extends entirely through the stropping disc 40 between the upper surface 40a and the lower surface 40b. It should be understood that the upper surface 40a and the lower surface 40b are in operative communication with one another at the opening 40e.

Stropping disc 40 and securing member 30 are attached by means of the first securing surface 30b coming into contact with the lower surface 40b of the stropping disc 40. Prior to such securement, a woodworker removes the first removable liner 30a so that the first securing surface 30b is exposed and may be attached to the lower surface 40b of the stropping disc 40. The opening 40e of the stropping disc 40 is also aligned with the opening 30e of the securing member 30 and the opening 20e of the support disc 20. The openings 20e, 30e, 40e should be aligned with one another therefore the openings 40e, 30e, 20e may receive the arbor 10. In one exemplary embodiment, opening 40e has the same diameter as opening 30e of securing member 30. In another exemplary embodiment, opening 40e may be defined by a diameter that is different than opening 40e. In another exemplary embodiment, opening 40e is not equal in diameter to opening 20e of support disc 20 but it may have equal diameters in another embodiment. In the present disclosure, openings 20e, 30e, 40e are coaxial along axis A of arbor 10.

With continued reference to FIG. 3 and FIG. 4, sharpening disc 50 of kit 1 has a removable liner 50a that attaches to and protects a securing surface 50b. Sharpening disc 50 also has a sharpening surface 50c which is opposite to the removable liner 50a. The sharpening surface 50c remains opposite to the securing surface 50b once the removable liner 50a is removed. Sharpening disc 50 also includes a peripheral wall 50d that extends between the removable liner 50a, the securing surface 50b and the sharpening surface 50c which defines the thickness of sharpening disc 50. In one embodiment, sharpening disc 50 may be a conventional sanding disc defining a particular abrasive substance or grit value.

Sharpening disc 50, stropping disc 40, and securing member 30 are in operative communication through the support disc 20. Sharpening disc 50 and support disc 20 are attached by securing surface 50b coming into contact with the lower surface 20b of the support disc 20. Prior to such securement, a woodworker removes the removable liner 50a so that the securing surface 50b is exposed and may be attached via adhesive or other chemical, mechanical, or non-chemical and non-mechanical connection to the lower surface 20b of the support disc 20. Stropping disc 40 and support disc 20 are attached by means of securing member 30. Stropping disc 40 and sharpening disc 50 are opposite one another in relation to the support disc 20.

The kit 1 may include any suitable number of sharpening discs 50. The kit 1 may include more than one sharpening disc 50 of the same surface or there could be a variety of sharpening disc 50 within kit 1. The sharpening disc 50 can vary in grit, texture, abrasiveness, etc. and there is no limit on the assortment of sharpening discs 50 that a woodworker may have.

As will be described in greater detail herein, a honing compound 60 may be placed on to the stropping disc 40. In one embodiment, the honing compound 60 is placed on the upper surface 40a of the stropping disc 40 and rotated about the upper surface 40a of the stropping disc 40. The honing compound 60 will leave residue 62 on the upper surface of the stropping disc 40 once the honing compound 60 has been in contact with the upper surface 40a of the stropping disc 40.

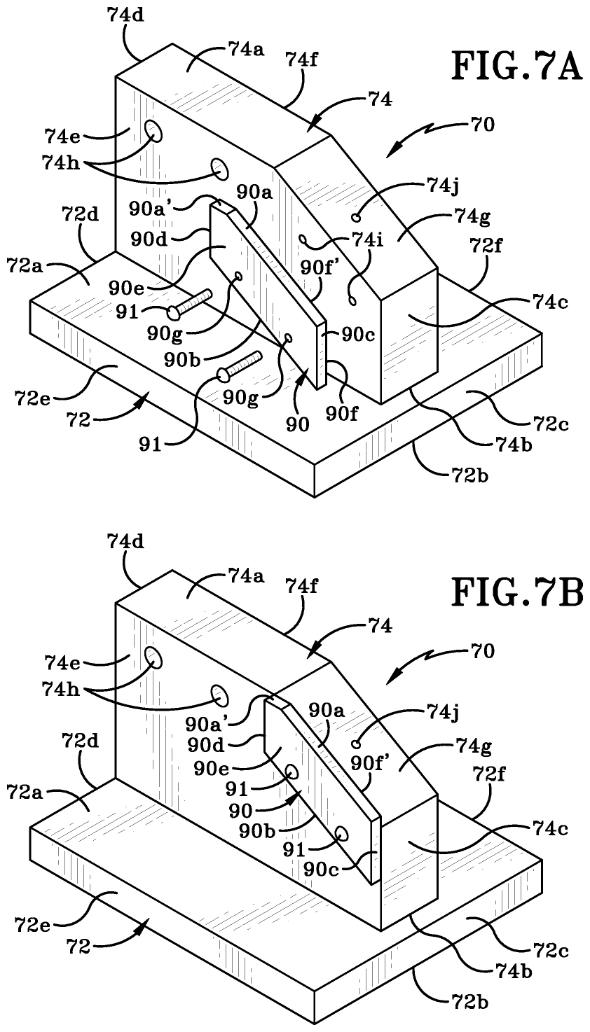

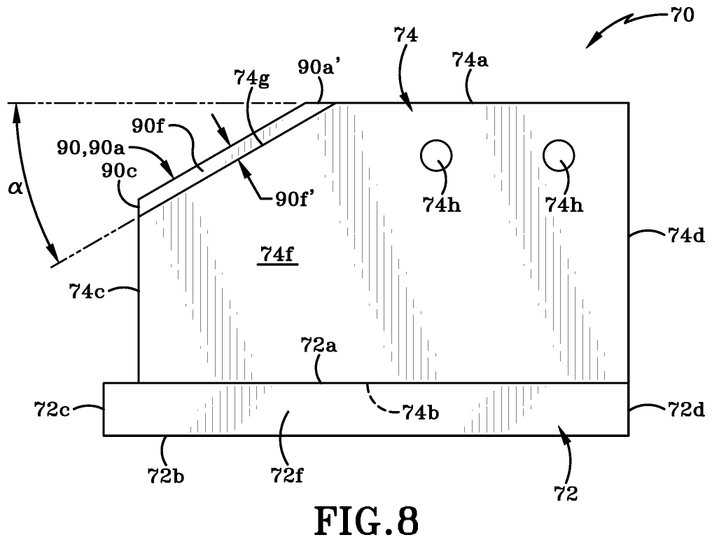

As best seen in FIG. 7A through FIG. 8, jig 70 has a base 72 and an upright support 74 that operably engages with the base 72. The base 72 has a top surface 72a and a bottom surface 72b that is opposite to the top surface 72a. The top surface 72a and the bottom surface 72b are also connected by a peripheral wall that includes a front wall 72c, a back wall 72d opposite to the front wall, a left wall 72e, and a right wall 72f that is opposite to the left wall 72e. In the present disclosure, the base 72 defines a rectangular shape when viewed from a top plan view. In another exemplary embodiment, base 72 may define any suitable shape dictated by the implementation of base 72.

Base 72 may be configured to rest on a work bench WB, drill press table TBL, and/or against a drill press fence F. As described in greater detail below, base 72 may be secured with or mounted to a work bench to maintain a desired position for a jig 70. Such components and features of the jig 70 and base 72 are described in greater detail herein.

The upright support 74 includes a top surface 74a and a bottom surface 74b that is opposite to the top surface 74a. The top surface 74a and the bottom surface 74b are also connected by a front wall section 74c, a back wall 74d that is opposite to the front wall section 74c, a left wall section 74e, and a right wall section 74f that is opposite to the left wall section 74e.

Still referring to FIG. 7A, upright support 74 also includes a sloped surface 74g. The sloped surface 74g extends along a portion of the top surface 74a between the front wall section 74c to a medial location defined between the front wall section 74c and the back wall 74d. Still referring to FIG. 7A, upright support 74 also defines a securing aperture 74j in the sloped surface 74g; such use and purpose of the securing aperture 74j is discussed in greater detail below. On the left wall section 74e or on the right wall section 74f, upright support 74 may define a set of attachment apertures 74i adjacent to the sloped surface 74g and the securing aperture 74j; such use and purpose of the set of attachment apertures 74i is also discussed in greater detail below.

Upright support 74 may also define at least one storage passageway 74h that extends entirely through the upright support 74 between the left wall section 74e to the right wall section 74f. It should be understood that the left wall section 74e and the right wall section 74f are in operative communication with one another at the at least one storage passageway 74h. In the present disclosure, upright support 74 defines a pair of storage passageways 74h that extends entirely through the upright support 74 between the left wall section 74e to the right wall section 74f. In other exemplary embodiments, upright support 74 may define any suitable number of storage passageways dictated by the implementation of such storage passageways, including the number of arbors included in a sharpening kit.

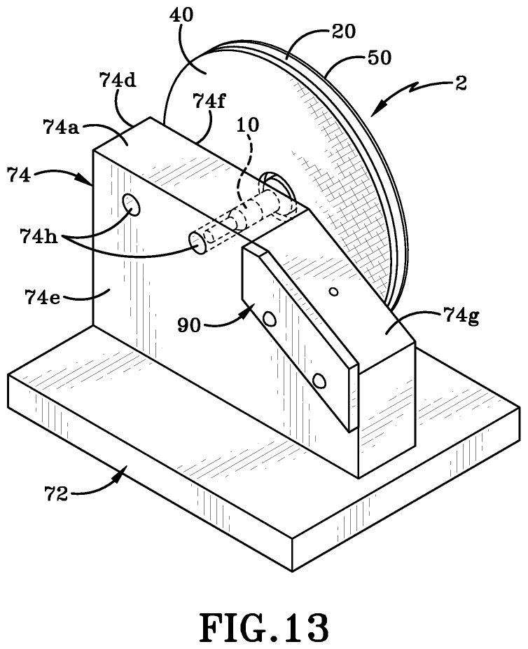

A woodworker may find the storage passageways 74h advantageous because in one exemplary embodiment a woodworker may store a fully assembled kit 1 on either the left wall section 74e or the right wall section 74f (see FIG. 13, for example). In another exemplary embodiment the storage passageways 74h may also be adapted to hold a number of sharpening discs 50 of the same surface or may hold multiple sharpening discs such as 50-1 and/or 50-2. The storage passageways 74h may also support multiple support discs 20 and/or stropping discs 40. The woodworker may decide what they would like to store on arbor 10 that is inserted into the storage passageway 74h.

As best seen in FIG. 8, the sloped surface 74g is also sloped at an angle α. In the present disclosure, the angle α at which the sloped surface 74g is sloped is defined between the top surface 74a of the upright support 74 and the front wall section 74c of the upright support. The angle of a can vary depending on a woodworker's needs and the tools to be sharpened by the woodworker. In one exemplary embodiment, the angle α may be an angle defined in a range from 1° up to a 30°. In another exemplary embodiment, the angle α may be an angle defined in a range from 25° up to 30°. In yet exemplary embodiment, the angle α may be approximately 25°. In yet another exemplary embodiment, the angle α may be approximately 30°.

A first fence 90 includes a flat top surface 90a′ that is adjacent to a top surface 90a. First fence 90 includes the top surface 90a and a bottom surface 90b that is opposite to the top surface 90a. The top surface 90a and the bottom surface 90b are connected between a front wall section 90c and a back wall section 90d that is opposite to the front wall section 90c. The top surface 90a is defined between the flat top surface 90a′ and the front wall section 90c The front wall section 90c and the back wall section 90d are also connected by an outer surface 90e and an inner surface 90f that is opposite to the outer surface 90e. First fence 90 also defines a set of apertures 90g that extends between the outer surface 90e and the inner surface 90f; the outer surface 90e and the inner surface 90f are in operative communication with one another at each aperture of the set of apertures 90g. The first fence 90 further includes a brace portion 90f′. The brace portion 90f′ is an area of the inner surface 90f of the fence 90 defined between the sloped surface 74g of the jig 70 and the top surface 90a of the first fence 90.

When desired by the woodworker, the first fence 90 connects with the jig 70 by a set of fasteners 91. FIGS. 7A-7B depict that each fastener of the set of fasteners 91 may threadably engage the first fence 90 at the set of apertures 90g with the upright support 74 at the set of attachment apertures 74i. Upon engagement, the inner surface 90d of the first fence 90 is directly touching the left wall section 74e of the upright support 74 of the jig 70. The set of apertures 90g of the first fence 90 and the set of attachment apertures 74i of the upright support 74 are aligned with one another so that the set of fasteners 91 are inserted through and threadably engage the first fence 90 in place with the upright support 74. Once engaged, a brace portion 90f′ of the first fence 90 sits above the sloped surface 74g that is measured along the inner surface 90f between the top surface 90a of first fence 90 and the sloped surface 74g (see FIG. 8). As discussed in greater detail below, a tool is configured to abut against the brace portion 90f′ so that the tool is free from laterally moving or shifting along the sloped surface 74g when said tool is being sharpened by kit 1.

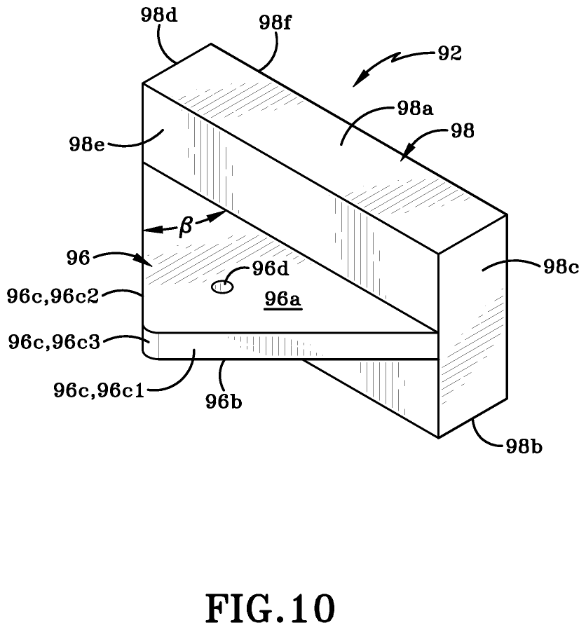

FIG. 10 depicts that a second fence 92 includes a brace 96. Brace 96 has an upper surface 96a and a lower surface 96b that is opposite to the upper surface 96a. A peripheral wall 96c is defined by the thickness of brace 96 extends between the upper surface 96a and lower surface 96b. The peripheral wall contains three sections; a first bracing wall 96c1, a second bracing wall 96c2, and a tip 96c3. The brace 96 also defines an aperture 96d extending between the upper surface 96a and the lower surface 96b.

With continued reference to FIG. 10, the second fence 92 also includes a base 98 that operably engages with the brace 96. The base 98 has a top surface 98a and a bottom surface 98b that is opposite to the top surface 98a. Base 98 has a front wall 98c that extends between the top surface 98a and the bottom surface 98b. Base 98 also has a rear wall 98d that extends between the top surface 98a and the bottom surface 98b and is opposite to the front wall 98c. Base 98 also has an inner wall 98e and an outer wall 98f that is opposite to the inner wall 98e. The brace 96 also connects to the inner wall 98e of the base 98.

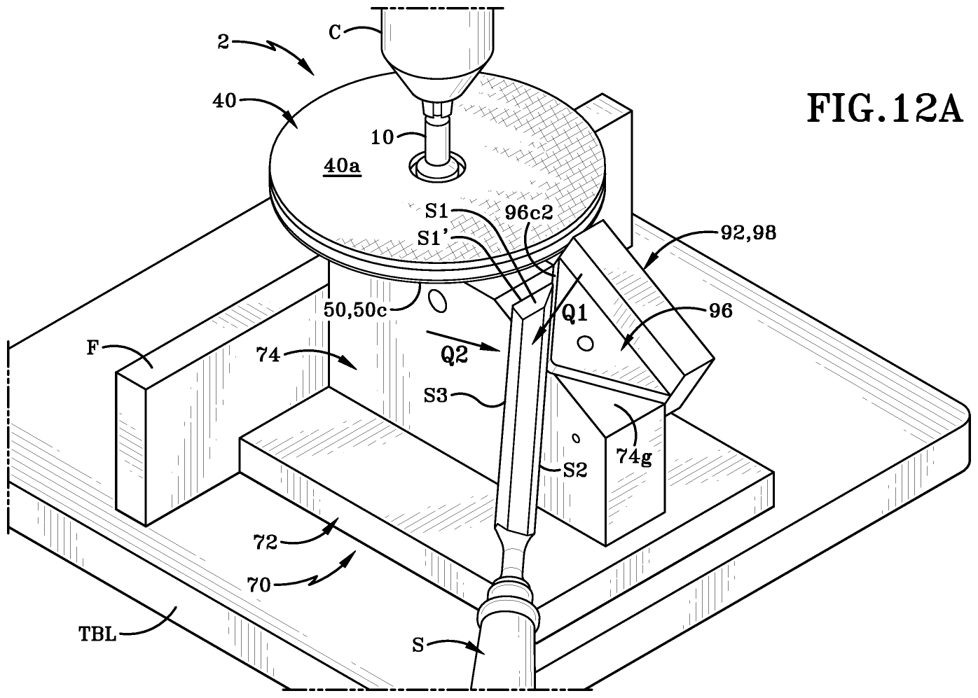

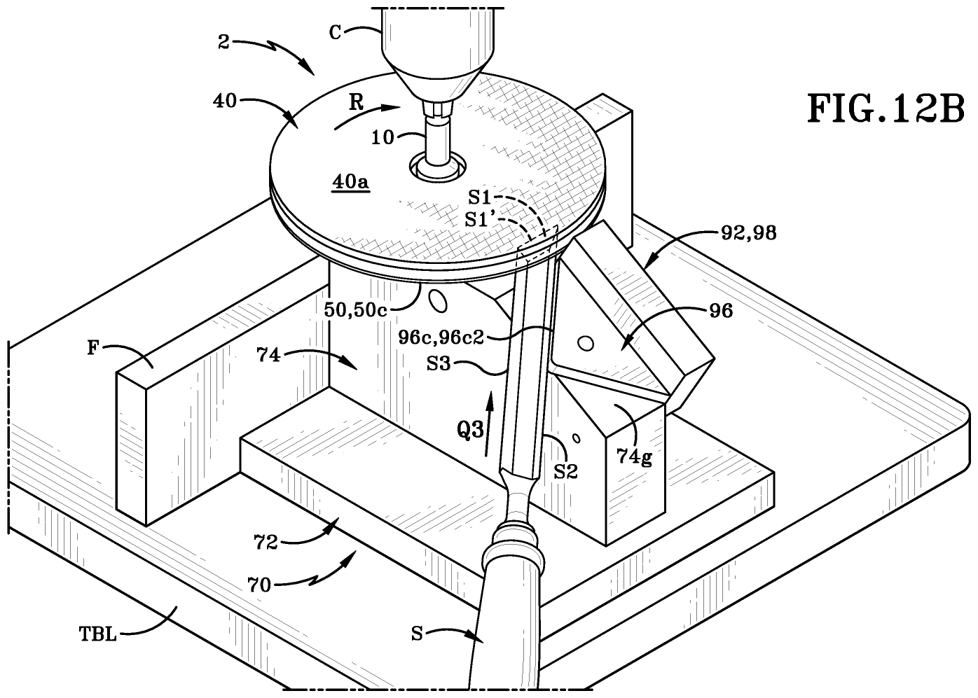

With continued reference to FIG. 10 and brace 96, the peripheral wall 96c is divided into a first bracing wall 96c1 and a second bracing wall 96c2. The first bracing wall 96c1 extends between the front wall 98c to a bend or tip 96c3 of the brace 96. The second bracing wall 96c2 extends between the rear wall 98d to the tip 96c3 of the brace 96. In operation, either the first bracing wall 96c1 or the second bracing wall 96c2 may be configured to contact and support a skew chisel or similar angled tool as skew chisel is being sharpened by the sharpening disc 50 of the sharpening assembly 2. In one exemplary instance, and as best seen in FIG. 12A, the second fence 92 may be provided in a first position where the base 98 engages with the right wall section 74f of the upright support 74 and the first bracing wall 96c1 engages and supports a skew chisel. In another instance, the second fence 92 may be provided in a second position (opposite to the first position) where the base 98 engages with the left wall section 74e of the upright support 74 and the second bracing wall 96c2 engages and supports a skew chisel.

It should be understood that the first bracing wall 96c1 and the second bracing wall 96c2 may be defined at any suitable angle β that is measured relative to the front wall 98c or the rear wall 98d. In one exemplary embodiment, each of the first bracing wall 96c1 and the second bracing wall 96c2 may be defined at angle β in within a range between 1° up to about 89° that is measured relative to the front wall 98c or the rear wall 98d. In one exemplary embodiment, each of the first bracing wall 96c1 and the second bracing wall 96c2 may be defined at angle β in a range between 25° up to about 45° that is measured relative to the front wall 98c or the rear wall 98d.

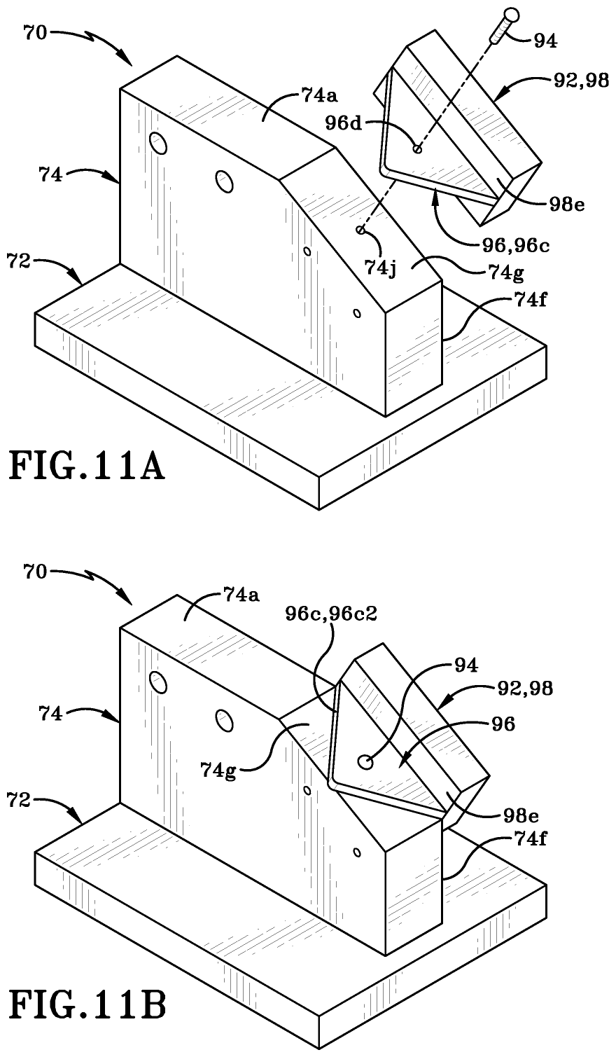

FIGS. 11A-11B depict that when desired by the woodworker, the second fence 92 connects with the jig by a fastener 94. The fastener 94 threadably engages the brace 96 of the second fence 92 at the aperture 96d with the upright support 74 at the securing aperture 74j. Upon engagement, the lower surface 96b of the brace 96 directly contacts the sloped surface 74g of the jig 70. The aperture 96d of the second fence 92 and the securing aperture 74j of the upright support 74 are aligned with one another so that the fastener 94 is inserted through and threadably engage the second fence 92 in place with the upright support 74.

Referring now to reference tool 110, the reference tool 110 may be a piece of flat and/or planar material that may be used to test a tool to determine if the tool is flat and/or planar after performing a sharpening operation on said tool with kit 1. The reference tool 110 may also have a set of feet 120 to ensure that the reference tool 110 does not move or break when in use. The reference tool 110 includes at least one planar or flat surface to ensure that the surface of a tool is flat and/or planar after performing a sharpening operation on said tool with kit 1. In one exemplary embodiment, reference tool 110 may be a glass plate that has planar and/or flat surfaces to ensure that the surface of a tool is flat and/or planar after performing a sharpening operation on said tool with kit 1.

The kit and/or system discussed and illustrated herein is considered advantageous at least because kit 1 advances the technology in the field for sharpening tools. Kit 1 enables a woodworker to sharpen their tools with minimal effort all while repurposing tools and items that are likely already in a woodworking workshop. Kit 1 is also considered advantageous at least because kit 1 provides an efficient alternative to sharpening tools than the regular sharpening machines that are routinely used. The current machines are bulky, take up a lot of space, cost a lot of money, require lubricant, and take a long time to sharpen. Kit 1 alleviates all of these concerns.

Another advantage of kit 1 is that the kit 1 enables woodworkers to sharpen tools without having to swap or switch components once the kit is assembled with the drill press. In one instance, the stropping disc 40 and the sharpening disc 50 may be attached to the support disc 20 and the combination of the discs are received by the arbor 10 so that the arbor 10 may be inserted into and secured with a drill press. Once arbor 10 is secured with the drill press, there is no need for woodworkers to switch back and forth to different systems or machines. As such, woodworkers may simply perform sharpening operations for desired tools, including various chisels, without the need of continuously changing or rearranging sharpening components. As such, kit 1 will decrease the amount of time to sharpen a tool, such as a chisel, as well as reduce the number of machines or devices needed to sharpen said tool.

Another advantage to kit 1 in this present disclosure is that there may be a variety of different configurations. The support disc 20 may support multiple different configurations. In one exemplary embodiment, the support disc 20 may have a stropping disc 40 attached by means of a securing member 30 on the upper surface 20a and have a sharpening disc 50 on the lower surface 20b of the support disc 20. In another exemplary embodiment, the support disc 20 may include a first sharpening disc 50-1 with a first sharpening surface 50c-1 on the upper surface 20a of the support disc 20 and a second a second sharpening disc 50-2 with a second sharpening surface 50c-2 on the lower surface 20b of the support disc 20 such that the first sharpening surface 50c-1 and the second sharpening surface 50c-2 are different from one another. In this exemplary embodiment, the first sharpening surface 50c-1 may be a first grit or abrasive surface and the second sharpening surface 50c-2 may be a second grit or abrasive surface that is different from the first sharpening surface 50c-1. A third exemplary embodiment could have the stropping disc 40 attached to the upper surface 20a of the support disc 20 by the securing member 30. All of the above embodiments are just some of the configurations that kit 1 would enable a woodworker to make when sharpening one or more types of tools.

Another advantage of kit 1 is the jig 70 that accompanies kit 1. The jig 70 provides stability when sharpening a tool with sharpening disc 50. The jig 70 provides support for the tool to ensure the desired angle of the tool is matched. The jig 70 further provides stability so that the woodworker does not need to free hand the sharpening. The stability that the jig 70 provides further assists in decreasing the amount of time necessary to sharpen a tool. The jig 70 is also able to adapt to receive different types of tools. In one exemplary embodiment, the jig 70 may receive tools with straight edges when the jig 70 is equipped with the first fence 90. In another exemplary embodiment, the jig 70 may receive tools with skewed edges when the jig 70 is equipped with the second fence 92. The jig 70 is also able to be adapted to receive other types of tools in other exemplary embodiments.

Having now described the components and parts of the kit 1, methods of sharpening one or more types of tools with kit 1 are discussed in greater detail below.

In operation, assembly 2 of kit 1 is assembled by first inserting the fastener 12 through the opening 20e of the support disc 20 from the lower surface 20b. Once the fastener 12 is inserted through the opening 20e, the arbor 10 may receive the fastener 12 and be secured in place where the fastener 12 threadably engages with the threaded passageway 10i. At this stage of assembly, the arbor 10 and support disc 20 are operably engaged with one another and may be ready to receive stropping disc 40 and sharpening disc 50.

Next, the woodworker may then secure the securing member 30 to the support disc 20. At this stage, the second removable liner 30c is to be removed by the woodworker to expose the second securing surface 30d. Once the second securing surface 30d is exposed it may be placed onto the upper surface 20a of the support disc 20 to secure the securing member 30 with the support disc 20. Once the securing member 30 is secured to the support disc 20, the stropping disc 40 may then be attached. To attach the stropping disc 40, the woodworker removes the first removable liner 30a from securing member 30 to expose the first securing surface 30b. Once the first securing surface 30b is exposed, the woodworker then places the lower surface 40b with the first securing surface 30b so that the securing member 30 and the stropping disc 40 are secured in place.

Lastly, the sharpening disc 50 may be attached to the support disc 20. To attach the sharpening disc 50, the woodworker removes the removable liner 50a to expose the securing surface 50b. Once the securing surface 50b is exposed, the woodworker then places the securing surface 50b onto the lower surface 20b of the support disc 20 so that the support disc 20 and the sharpening disc 50 are secured with one another.

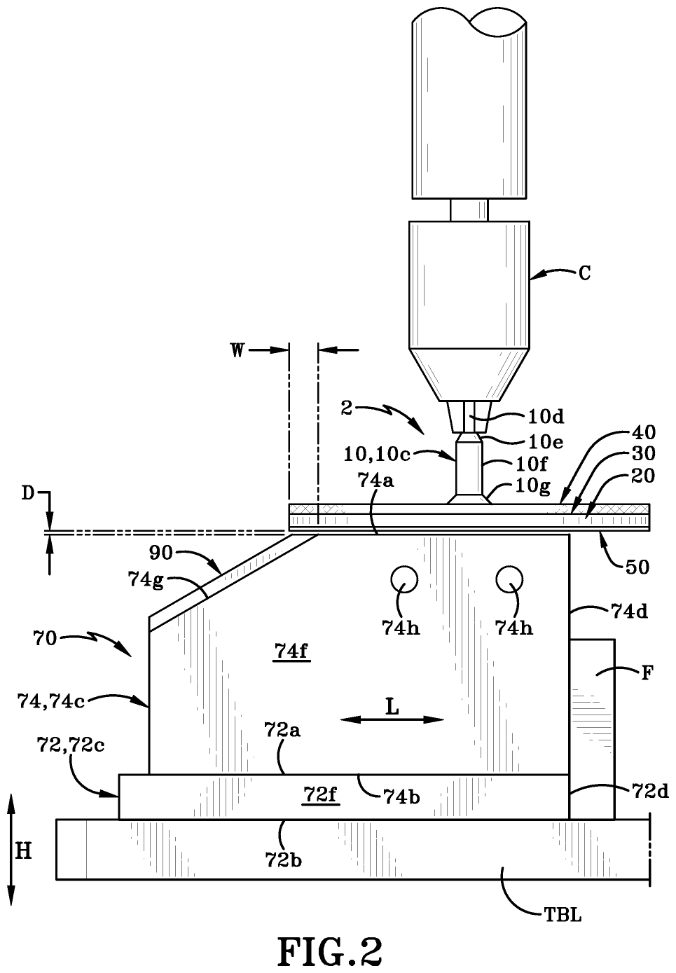

At this stage, the woodworker may then attach the assembly 2 with a drill press (labeled “DP” in FIGS. 1-2) to retrofit the drill press into a device that can be used to sharpen a tool, such as a chisel. As best seen in FIG. 2, arbor 10 is operably engaged with a chuck (labeled “C” in FIGS. 1-2) so that assembly 2 is suspended, hangs downward, or is otherwise equipped to the drill press. It should be understood that once the arbor 10 is equipped to the drill press, the woodworker may vary the height of the sharpening assembly 2 by lowering or raising the workbench based on the placement of the jig 70 relative to the sharpening disc 50, which is discussed in greater detail below; such movement of the workbench is denoted by a double arrow labeled “H” in FIG. 2.

In operation, the kit 1 is further assembled by constructing the jig 70. To construct the jig 70, the woodworker may make the upright support 74. The woodworker may cut two pieces of hardwood to approximately 5″×8″ and glue these pieces together. Once the glue has completely dried, the woodworker may then cut the two pieces that are together to 4″×7″. Next, the woodworkers may mark the upright support 74 to the desired angle for the jig while making sure that the length of the sloped surface 74g is at least 3″. Next, the woodworker may remove the corners that are marked to create the sloped surface 74g. The woodworker may then ease all the edges except for the sloped surface edges to leave the sloped surface as wide as possible. The woodworker may create the first fence 90. To create first fence 90, the woodworker may cut a piece of hardwood approximately 1¼″ wide and about 4½″ long to create the first fence 90. Then, the woodworker may cut both the front wall section 90c and the back wall section 90d to match the length of the sloped surface 74g. Next, the woodworker may trim off the corner of the fence that is the ear to create the flat top surface 90a′ so that it lays flush with the top surface 74a of the upright support 74. To secure the first fence 90 to the upright support 74, the woodworker may use the fasteners 91 and threadably engage them through the apertures 90g on the first fence 90 and through the first fence 90 into the apertures 74i on the upright support 74 to secure the first fence 90 into place.

Another step of assembling the jig 70 is to construct the base 72. The woodworker may first cut a piece of hardwood to measure out to 6″×7½″ and ease all the edges except for the back wall 72d. Next, the woodworker may drill countersunk holes in the bottom of the base 72 at 2″ and 5″ on center. The woodworker may then drill small pilot holes in the bottom of the upright support 74 also at 2″ and 5″ on center. With screws, the woodworker may attach the upright support 74 to the base 72. Next, the woodworker may line up the back wall 72d of the base 72 and the back wall 74d of the upright support 74 against a flat surface to ensure that the back face of the base 72 and the upright support 74 are aligned.

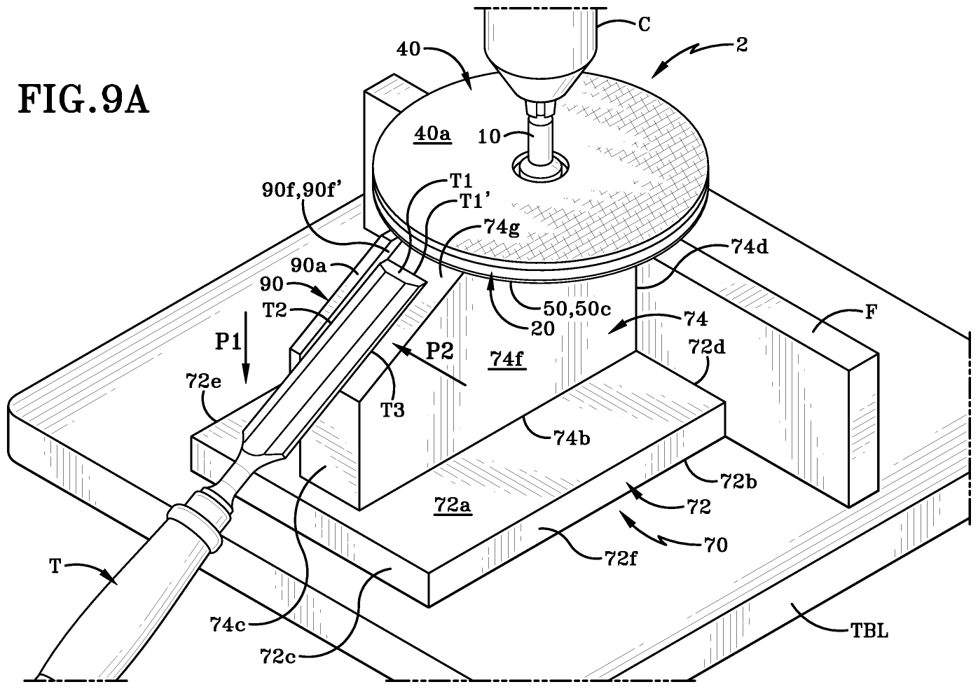

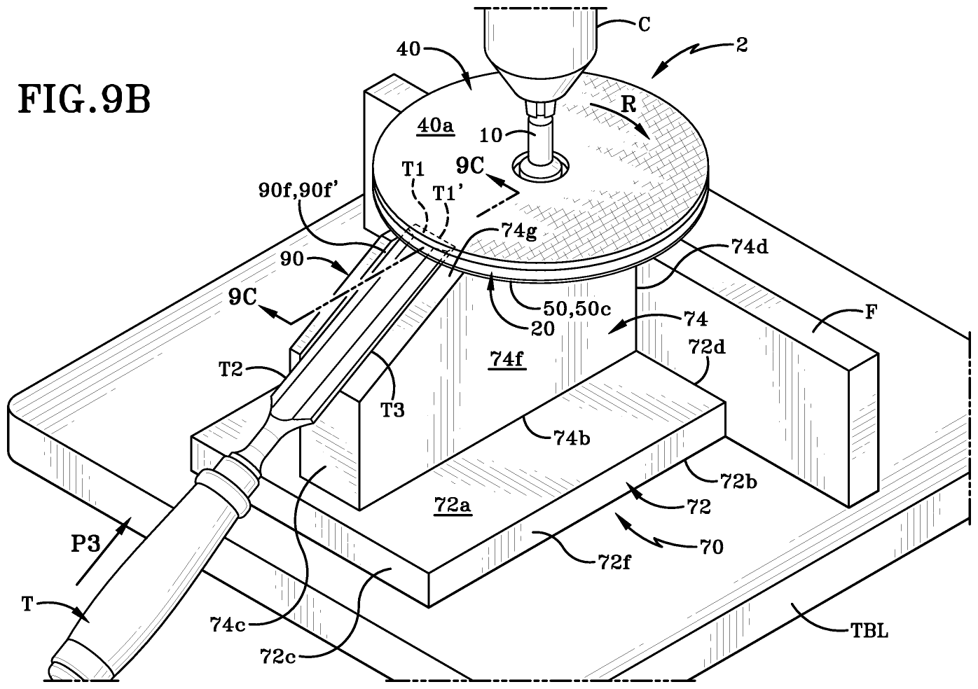

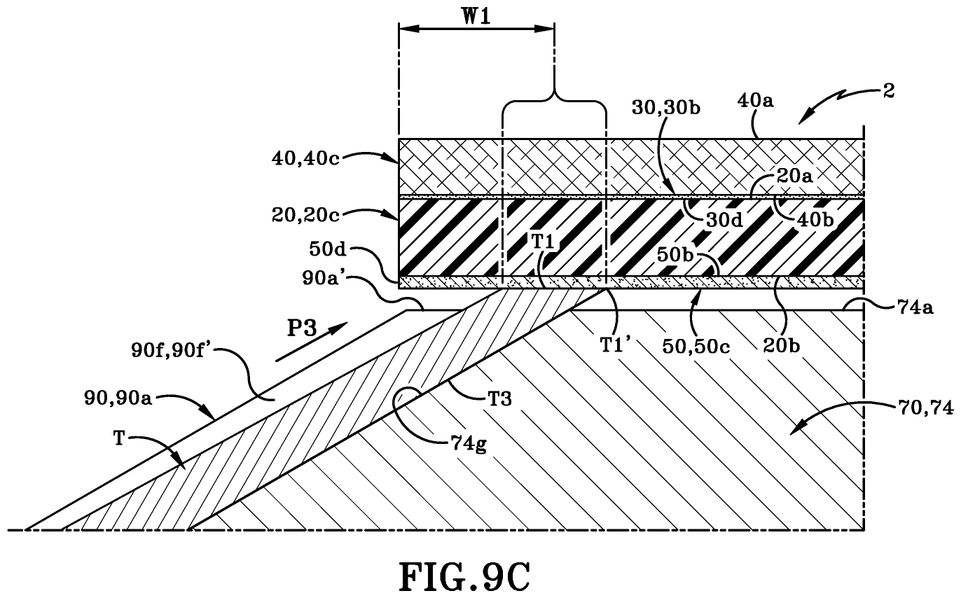

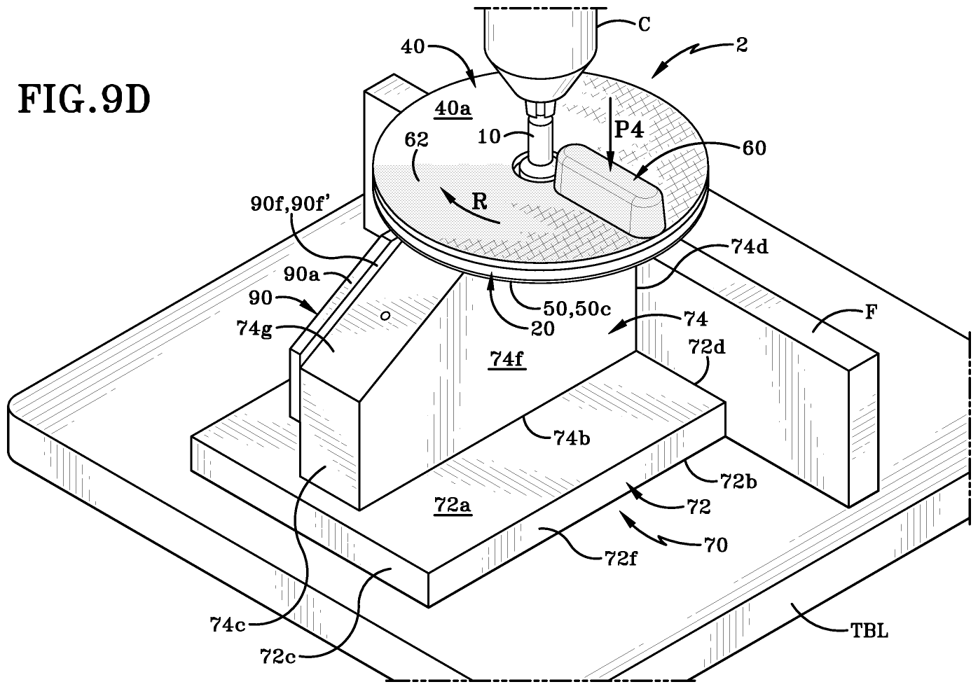

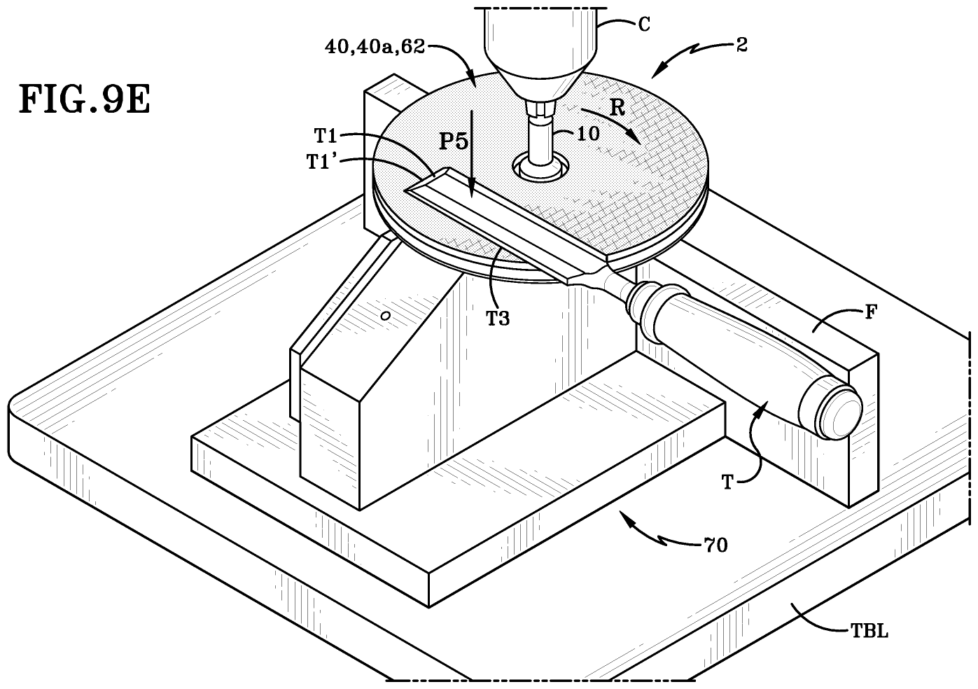

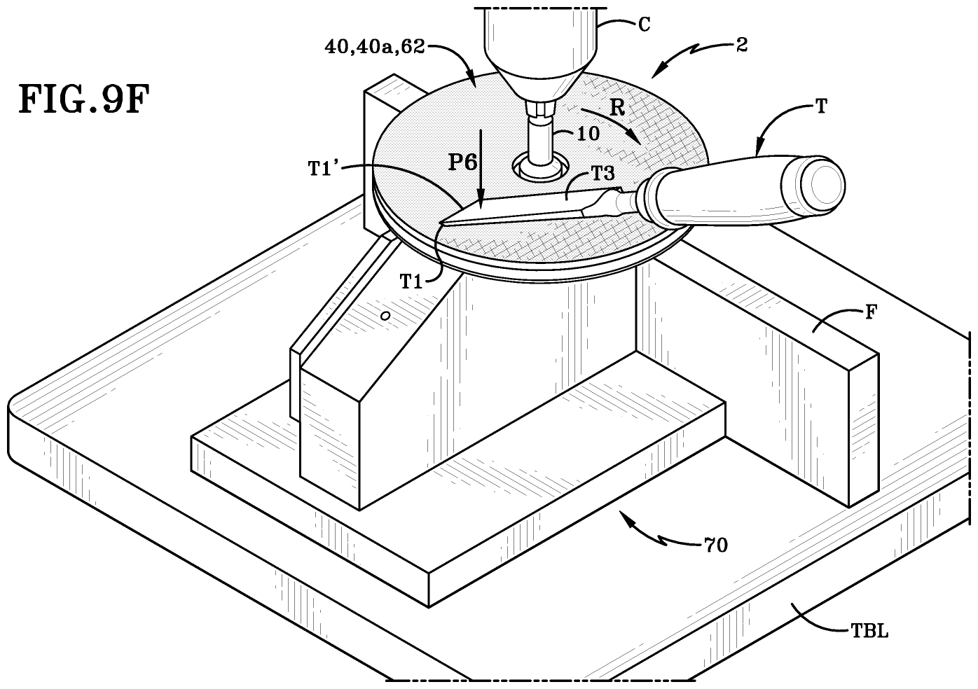

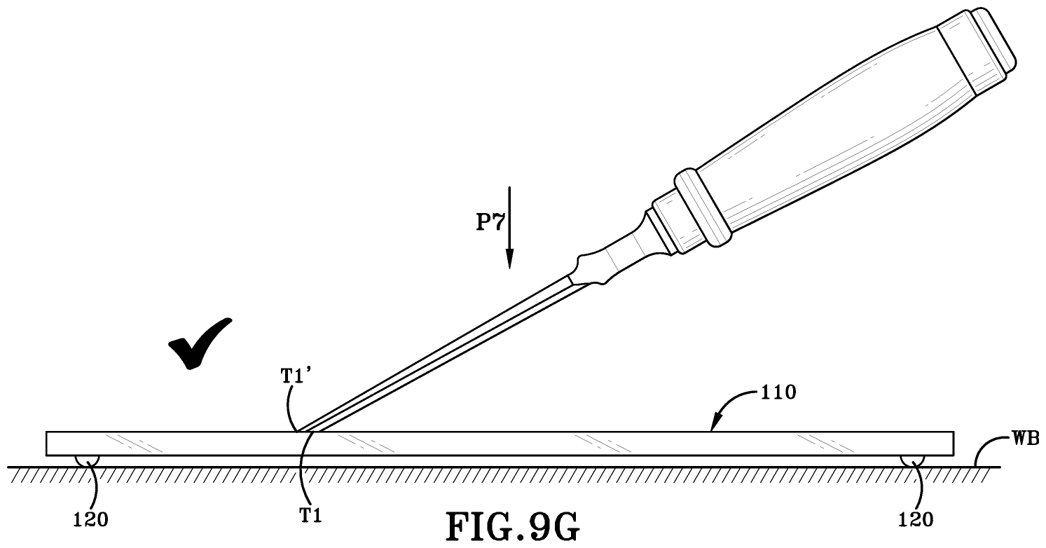

Prior to sharpening a tool with kit 1, the woodworker may select and equip the first fence 90 with the jig 70 for sharpening a first tool (labeled “T” in FIGS. 9A-9C). As discussed previously, the first fence 90 is equipped to the jig 70 by the woodworker operably engaging fasteners 91 with the jig 70 (at the set of attachment apertures 74i) and with the first fence 90 (at the set of apertures 90g). Once engaged, the woodworker may then place the jig 70 on the worktable of the drill press. At this stage, the woodworker may then calibrate the jig 70 with the sharpening disc 50 if the jig 70 is uneven or not substantially parallel with the sharpening disc 50. In one instance, the woodworker may apply a removable shim or level element (e.g., removable tape or similar elements of the like) to the bottom surface 72b of the base 72 until jig 70 is perfectly parallel with the sharpening disc 50. The woodworker may also vary the height of the kit 1 based on the placement of the jig 70 relative to the sharpening disc 50. Such varying in height is controlled by the woodworker moving the work bench of the drill press; such movement of the work bench to vary the height of the kit 1 is denoted by double arrows labeled “H” in FIG. 2.

Once the kit 1 and jig 70 are equipped with the drill press and the drill press table TBL, the woodworker may vary the horizontal placement of the jig 70 relative to the sharpening disc 50 to set a desired sharpening width along the sharpening disc 50; such sharpening width is denoted by double arrows labeled “W” in FIG. 2. As best seen in FIG. 2, the woodworker may horizontally move the jig 70 along the drill press table TBL by adjusting the fence F until the woodworker has set a desired sharpening width; such movement of the jig 70 is denoted by double arrows labeled “L” in FIG. 2. It should be understood that the sharpening width of the sharpening disc 50 is measured between the peripheral wall 50d of the sharpening disc 50 and an edge defined between the top surface 74a of the jig 70 and the sloped surface 74g.

Once the jig 70 is calibrated with the drill press table TBL and the drill press, the woodworker may then introduce the tool, such as a chisel (labeled “T” in FIGS. 9A-9C and 9E-9F and is shown as a straight chisel) to the kit 1 and jig 70 for sharpening purposes.

As best seen in FIG. 9A, the tool is introduced to kit 1 and jig 70 where a cutting surface (T1) of the tool is placed into contact with the sharpening surface 50c by a woodworker. At the same time, the woodworker may rest a bottom surface (T3) of the tool against the sloped surface 74g of the upright support 74 to ensure that the angle α is correct for the specific tool that the woodworker may use (shown by arrow “P1” in FIG. 9A). The woodworker may place the non-cutting edge of the tool (T2) in contact with the brace portion 90f′ at the section that is above 74g (shown by arrow “P2” in FIG. 9A)

As best seen in FIG. 9B, once the tool is introduced to the drill press, the woodworker may turn the drill press on which allows the motor (M) to rotate kit 1; such rotation is denoted by arrows labeled “R” in FIG. 9B. In one exemplary embodiment the motor M of the drill press DP may rotate sharpening assembly 2 at a rotational speed from 400 rpm to 600 rpm. As the motor M rotates kit 1, a woodworker may perform a first sharpening operation. The woodworker may slide the tool up the sloped surface 74g (shown by arrow “P3” in FIG. 9B) so that the sharpening surface 50c of sharpening disc 50 may sharpen the tool at the cutting surface T1 to create a sharpened cutting edge T1′. FIG. 9C clearly shows the cutting surface T1 contacting the sharpening surface 50c (shown by W1 in FIG. 9C). The non-cutting edge T2 is in contact with the first fence at 90f′ and in contact with the sloped surface 74g of the upright support 74 of the jig 70. This step may be repeated as many times as the woodworker feels necessary to achieve the sharpness desired by the woodworker.

As best seen in FIG. 9D, the woodworker may press the honing compound 60 on the upper surface 40a of the stropping disc (shown by arrow “P4” in FIG. 9D). To spread the honing compound 60 along the upper surface 40a of the stropping disc 4, the woodworker may then turn the motor M of the drill press DP to an operating state so that kit 1 begins to rotate (shown by arrow “R” in FIG. 9D) leaving residue 62 on the upper surface 40a of the stropping disc. The woodworker may coat the entire upper surface 40a of the stropping disc 40. This step may be repeated if the layer of honing compound 60 deteriorates after use if the woodworker feels it is necessary.

As best seen in FIG. 9E, the woodworker may then place the tool on the stropping disc 40 that is coated with the honing compound 60. The woodworker may polish the bottom surface T3 as best seen in FIG. 9E by the woodworker pressing down on to the stropping disc 40 with the tool while the motor M of the drill press DP is rotating the kit 1 (shown by arrow “P5” in FIG. 9E). The woodworker may also polish the top surface of the cutting surface T1 (as best seen in FIG. 9F) by the same operation as depicted in FIG. 9E (shown by arrow “P6” in FIG. 9F). The woodworker may turn the tool around as much as the woodworker believes is necessary to achieve a desired finish of the tool.

After the tool is sharpened, the woodworker may then evaluate the shape of the cutting edge T1′ of the tool by using the reference tool 110 (shown by arrow “P7” in FIG. 9G). The reference tool 110 may be placed directly on a work bench WB or surface, or the reference tool 110 may be raised and supported by feet 120 that are placed onto the reference tool 110 to ensure that the reference tool 110 does not move and does not break. The woodworker may then confirm that the tool has an acceptable edge and cease sharpening of that specific tool.

Another embodiment of jig 70 could include a second fence 92. The woodworker may select and equip the second fence 92 with the jig 70 for sharpening a second tool (labeled “S” in FIGS 12A-12B and is shown as a skew chisel). As discussed previously, the second fence 92 is equipped to the jig 70 by the woodworker operably engaging fastener 94 with the jig 70 at the securing aperture 74j and with the brace 96 at the aperture 96d. Once the fastener 94 is engaged with the brace 96 at the aperture 96d and with the upright support 74 at the securing aperture 74j, the inner wall 98e of the base 98 will rest on either the left wall section 74e (in the second position) or the right wall section 74f (in the first position) of the upright support 74 depending on design of the tool. Such positioning of the brace 96 relative to the upright support 74 enables either the first bracing wall 96c1 or the second bracing wall 96c2 to engage and support the second tool. In the present disclosure, the brace 96 rests and engages with the right wall section 74f in the first position in which the first bracing wall 96c1 will engage and support the second tool.

Once engaged, the woodworker may then place the jig 70 on the worktable of the drill press. The woodworker may then begin the process to sharpen the second tool. A cutting surface S1 of the second tool would come into contact with the sharpening disc 50 while a non-cutting edge S2 of the second tool would come into contact with the first bracing wall 96c1 of the brace 96 (shown by arrow “Q2” in FIG. 12A) and the bottom surface S3 would rest on the sloped surface 74g (shown by arrow “Q1” in FIG. 12A). The woodworker may then slide the second tool S so that it contacts the sharpening disc 50 (shown by arrow “Q3” in FIG. 12B). The cutting surface S1 will remain in contact with the sharpening disc 50 to sharpen the cutting surface S1 to create the cutting edge S1′. At this stage, the woodworker may then repeat the above steps (shown in FIG. 9D-9G) when polishing the second tool S with the stropping disc 40 and confirming the shape of the cutting edge S1′ with the reference tool 100.

Another embodiment of the jig 70 may be how it is secured to the drill press table of the woodworker. If the woodworker does not have a flat fence on their drill press to ensure the back wall 72d of the base 72 and the back wall 74d of the upright support 74 are aligned, then the woodworker may secure the jig using a different method. The woodworker may use magnets to hold the jig in place if the table is metal. To use a magnet the woodworker may drill a hole on both sides of the upright support 74 into the base 72 that extends between the top surface 72a and the bottom surface 72b. The magnet may then be inserted into the hole to hold the jig 70 in place. In one exemplary embodiment, the jig 70 may be equipped with one or more releasably magnetic device (such as a Magswitch® magnetic fixturing clamps) to quickly secure the jig 70 to a drill press table TBL of a drill press or other similar metal worktops or supports.

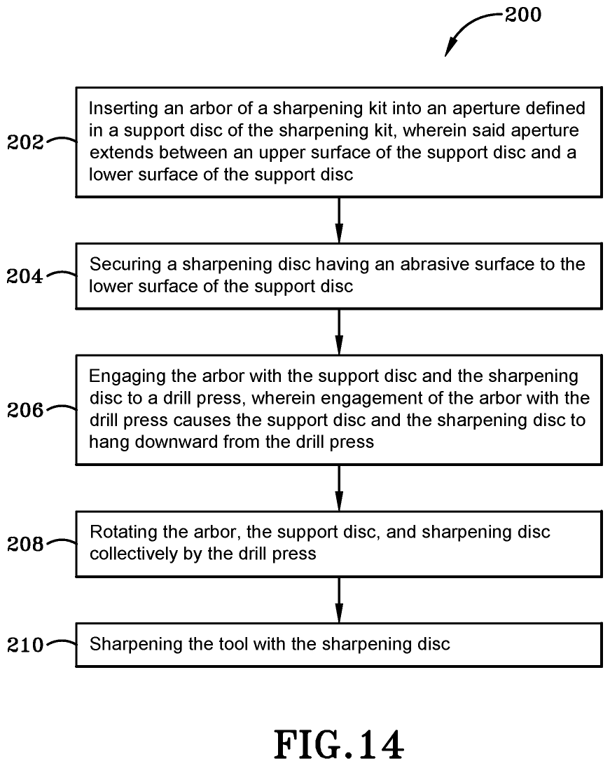

FIG. 14 illustrates a method 200 of sharpening a tool. An initial step 202 of method 200 includes inserting an arbor of a sharpening kit into an aperture defined in a support disc of the sharpening kit, wherein said aperture extends between an upper surface of the support disc and a lower surface of the support disc. Another step 204 of method 200 includes securing a sharpening disc having an abrasive surface to the lower surface of the support disc. Another step 206 of method 200 includes engaging the arbor with the support disc and the sharpening disc to a drill press, wherein engagement of the arbor with the drill press causes the support disc and the sharpening disc to hang downward from the drill press. Another step 208 of method 200 includes rotating the arbor, the support disc, and the sharpening disc collectively by the drill press. Another step 210 of method 200 includes sharpening the tool with the sharpening disc.

In other exemplary embodiments, method 200 (shown in FIG. 14) may include optional or additional steps of positioning a jig of the sharpening kit below the abrasive surface; and supporting the tool on a sloped surface of the jig. Optional or additional steps may further include engaging a fence with an upright support of the jig, wherein the fence is positioned adjacent to the sloped surface; and supporting the tool with the fence. Optional or additional steps may further include engaging a fence with the sloped surface of the jig; and supporting a second tool with the sloped surface and the fence. Optional or additional steps may further include engaging a stropping disc to the upper surface of the support disc. Optional or additional steps may further include coating the stropping disc with a honing compound. Optional or additional steps may further include referencing the tool to a reference tool subsequent to being sharpened by the sharpening disc. Optional or additional steps may further include checking a cutting edge of the tool to a reference tool subsequent to being sharpened by the sharpening disc

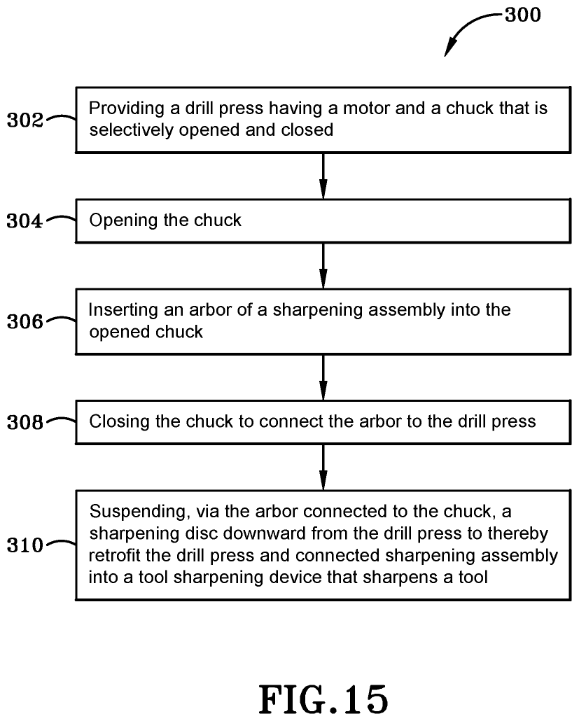

FIG. 15 illustrates a method 300 of retrofitting a drill press into a tool sharpening device. An initial step 302 of method 300 includes providing a drill press having a motor and a chuck that is selectively opened and closed. Another step 304 of method 300 includes opening the chuck. Another step 306 of method 300 includes inserting an arbor of a sharpening assembly into the opened chuck. Another step 308 of method 300 includes closing the chuck to connect the arbor to the drill press. Another step 310 of method 300 includes suspending, via the arbor connected to the chuck, a sharpening disc downward from the drill press to thereby retrofit the drill press and connected sharpening assembly into a tool sharpening device that sharpens a tool.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it may be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” may encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A sharpening kit comprising:
a sharpening assembly, the sharpening assembly including:
a support disc having an upper surface and a lower surface, wherein the support disc defines an aperture that extends between the upper surface and the lower surface of the support disc;
a sharpening disc having an abrasive surface, wherein the sharpening disc is configured to connect to one of the lower surface of the support disc and the upper surface of the support disc; and
an arbor receivable through the aperture in the support disc, wherein the arbor is adapted to connect a drill press to cause the sharpening assembly to hang downwardly therefrom;
wherein when the sharpening assembly is connected to the drill press, the drill press is retrofit to sharpen a tool via the sharpening assembly.

2. The sharpening kit of claim 1, wherein the sharpening assembly further comprises:
a stropping disc operably engageable with the upper surface of the support disc.

3. The sharpening kit of claim 2, wherein the sharpening assembly further comprises:
a first adhesive layer between the support disc and the stropping disc; and
a second adhesive layer between the support disc and the sharpening disc.

4. The sharpening kit of claim 3, further comprising:
a honing compound adapted to be spread along an upper surface of the stropping disc.

5. The sharpening kit of claim 1, further comprising:
a jig having a sloped surface; wherein the jig is adapted to support the tool to be sharpened by the abrasive surface of the sharpening disc.

6. The sharpening kit of claim 5, further comprising:
a fence that is removably engaged with the jig;
wherein the fence is adapted to support the tool to be sharpened by the abrasive surface.

7. The sharpening kit of claim 6, wherein the jig further comprises:
a base;
an upright support operably engaged with the base and defining the sloped surface; and
at least one mounting surface defined along the upright support and being adjacent to the sloped surface;
wherein the fence is removably engaged with the at least one mounting surface.

8. The sharpening kit of claim 7, further comprising:
a storage passageway defined by the base or the upright support; wherein the arbor is configured to be receivable by the jig at the storage passageway.

9. The sharpening kit of claim 6, wherein the fence comprises:
a brace removably engaged with the sloped surface between a first position and a second position relative to the sloped surface;
wherein the brace is adapted to support a second tool in the first position or the second position.

10. The sharpening kit of claim 9, wherein the fence comprises:
a first bracing wall of the brace;
wherein the first bracing wall is adapted to support the second tool in the first position.

11. The sharpening kit of claim 10, wherein the fence further comprises:
a second bracing wall of the brace opposite to the first bracing wall;
wherein the second bracing wall is adapted to support the second tool in the second position.

12. The sharpening kit of claim 1, wherein the sharpening assembly further comprises:
a second sharpening disc having a second abrasive surface and configured to connect to the upper surface of the support disc;
wherein the second abrasive surface of the second sharpening disc and the abrasive surface of the sharpening disc are different from one another.

13. The sharpening kit of claim 1, further comprising:
a reference tool adapted to check the tool subsequent to being sharpened by the sharpening disc.

14. A method of sharpening a tool, comprising:
inserting an arbor of a sharpening kit into an aperture defined in a support disc of the sharpening kit, wherein said aperture extends between an upper surface of the support disc and a lower surface of the support disc;
securing a sharpening disc having an abrasive surface to the lower surface of the support disc;
engaging the arbor with the support disc and the sharpening disc to a drill press, wherein engagement of the arbor with the drill press causes the support disc and the sharpening disc to hang downward from the drill press;
rotating the arbor, the support disc, and the sharpening disc collectively by the drill press; and
sharpening the tool with the sharpening disc.

15. The method of claim 14, further comprising:
positioning a jig of the sharpening kit below the abrasive surface; and
supporting the tool on a sloped surface of the jig.

16. The method of claim 15, further comprising:
engaging a fence with an upright support of the jig, wherein the fence is positioned adjacent to the sloped surface; and
supporting the tool with the fence.

17. The method of claim 15, further comprising:
engaging a fence with the sloped surface of the jig; and
supporting a second tool with the sloped surface and the fence.

18. The method of claim 14, further comprising:
engaging a stropping disc to the upper surface of the support disc;
coating the stropping disc with a honing compound.

19. The method of claim 14, further comprising:
checking a cutting edge of the tool to a reference tool subsequent to being sharpened by the sharpening disc.

20. A method of retrofitting a drill press into a tool sharpening device, the method comprising:
providing the drill press having a motor and a chuck that is selectively opened and closed;
opening the chuck;
inserting an arbor of a sharpening assembly into the opened chuck;
closing the chuck to connect the arbor to the drill press;
suspending, via the arbor connected to the chuck, a sharpening disc downward from the drill press to thereby retrofit the drill press and the connected sharpening assembly into the tool sharpening device that sharpens a tool.
